(19) United States
(12) Patent Application Publication
(10) Pub. No.: US 2025/0167265 A1
(43) Pub. Date: May 22, 2025

(54) FUEL CELL STACK ARRANGEMENT AND A METHOD FOR TREATMENT OF CATHODE INTAKE AIR

(71) Applicant: Grimaldi Development AB, Nacka Strand (SE)

(72) Inventors: Francesco Zitarosa, Illertissen (DE); Christoph Erdmann, Ulm (DE); Claes Inge, Nacka (SE); Peter Franzén, Bandhagen (SE); Carl Petrus Häggmark, Täby (SE); Dan Öivind Karlsson, Grödinge (SE)

(73) Assignee: GRIMALDI DEVELOPMENT AB, Nacka Strand (SE)

(21) Appl. No.: 18/838,850

(22) PCT Filed: Feb. 22, 2023
(86) PCT No.: PCT/EP2023/054406

§ 371 Date: Aug. 15, 2024

(30) Foreign Application Priority Data
Feb. 22, 2022 (SE) 2250235-5

(51) Int. Cl. H01M 8/04119; B01D 45/04; B01D 45/14; H01M 8/04029; H01M 8/0662

(52) U.S. Cl. CPC H01M 8/04126; B01D 45/04; B01D 45/14; H01M 8/04029; H01M 8/04164; H01M 8/0662

(57) ABSTRACT

The present invention relates to a fuel cell stack arrangement (1) comprising a fuel cell stack (3) comprising a plurality of fuel cells (3′). Each fuel cell (3′) comprises an anode side (4) comprising a fuel inlet (5) and a fuel outlet (6), a cathode side (7) comprising an air inlet (8) and an air outlet (9), and an electrolyte (24) arranged between the anode side (4) and the cathode side (7). The fuel cell stack arrangement (1) further comprises a cathode air intake (10) arranged upstream from the air inlet (8), a cathode air compressor (11) arranged downstream from the cathode air intake (10) and a hydrogen gas storage tank (12) arranged upstream from the fuel inlet (5). The fuel cell stack arrangement (1) further comprises a first separating unit (13) comprising at least one disc stack separator (14) and being arranged between the cathode air intake (10) and the air inlet (8).

### TECHNICAL FIELD

The present invention relates to a fuel cell stack arrangement comprising an improved system for treatment of the intake air, and to a method for treatment of the intake air of the fuel cell stack.

### BACKGROUND OF THE INVENTION

The impact of global warming is becoming ever more obvious, given increasing number of natural disasters such as flooding and temperature anomalies. Growing awareness and concern have led to an intense search of alternative energy sources, e.g. for propulsion of vehicles and vessels, power plants, or other energy applications.

One alternative that has emerged as a promising solution to the global warming problem is using fuel cells in automotive and marine industry. A fuel cell is an electrochemical cell that converts the chemical energy of a fuel and an oxidizing agent into electricity through a pair of redox reactions. There are many types of fuel cells, but they all consist of an anode, a cathode, and an electrolyte that allows ions, oftentimes protons, to move between the two sides of the fuel cell. At the anode, a catalyst causes the fuel to undergo oxidation reactions that generate ions and electrons. The ions move from the anode to the cathode through the electrolyte. At the same time, electrons flow from the anode to the cathode through an external circuit, producing direct current electricity. At the cathode, another catalyst causes ions, electrons, and oxygen to react, forming water and possibly other products. Thus, in addition to electricity, fuel cells produce water, heat and, depending on the fuel source, very small amounts of nitrogen dioxide and other emissions. A large number of fuel cells may be arranged in series and/or in parallel to form a fuel cell stack.

A common type of fuel cells is proton exchange membrane (PEM) fuel cell consisting of electrodes which are separated from each other by a semipermeable proton-conducting polymer membrane. A proton-exchange membrane, or polymer-electrolyte membrane (PEM), is a semipermeable membrane generally made from ionomers and designed to conduct protons while acting as an electronic insulator and reactant barrier, e.g. to oxygen and hydrogen gas. On the anode side, hydrogen diffuses to the anode catalyst where it dissociates into protons and electrons. The protons are conducted through the membrane to the cathode, while the electrons are forced to travel in an external power supplying circuit because the membrane is electrically insulating. On the cathode catalyst, oxygen molecules react with the electrons which have travelled through the external circuit and protons to form water.

Oxygen originating from compressed air is oftentimes used as the oxidizing agent in fuel cells. During operation, the core components of a fuel cell are highly sensitive to particles, harmful gases, and water present in the intake air. Furthermore, harmful gases can cause irreversible damage to the catalyst which is coated with noble metals, such as platinum or gold. Thus, the intake air needs to be purified in order to prevent the fuels cells from premature degradation. Further, the compressed air may need to be humidified, e.g. when the fuel cell is a PEM fuel cell. In order to ensure trouble-free operation and prolonged system lifetime, the filtration of particles and the adsorption of harmful gases is therefore equally important as efficient water droplet separation and humidification.

Currently available fuel cell arrangements comprise complex systems for treatment of the intake air before it is allowed to enter the fuel cell. In particular, such a system may comprise a particle filter layer separating particulate matter from the intake air. Dedicated activated carbon layers of the filter element may be used to adsorb harmful gases such as sulphur dioxide (SO₂), nitrogen oxide (NOx) and ammonia (NH₃), and therefore protect the valuable catalyst of the fuel cell against contamination and degradation.

As mentioned above, a sufficiently high level of humidity is necessary for the optimal operation of the fuel cell. For instance, if the intake air is too dry, this will have a negative effect on the proton conductivity of the proton exchange membranes in the PEM fuel cell stack. Therefore, a humidifier may add process water in the form of water vapor caused by evaporation and/or very fine mist from the cathode air exhaust to the intake air to increase the humidity. As a result of the process, water that is not evaporated may form water droplets which are separated by a cathode water separator to protect the stack. The water produced by the fuel cells is guided by an exhaust duct back to the humidifier, wherein humidity is transferred to the intake air. Excess water is removed by means of a water separator to protect the fuel cells against water impact.

Therefore, there is a need for an improved fuel cell stack arrangement, wherein the intake air is efficiently purified such that particles and water are removed, and wherein the intake air is humidified if needed.

### SUMMARY OF THE INVENTION

In view of the above, the present invention provides a fuel cell stack arrangement wherein water droplets and particles that disturb the fuel cells are removed from the cathode air, wherein the cathode air may be humidified and cooled, and wherein gaseous contaminants that are harmful to the catalysts may be removed. A fuel cell stack arrangement according to the present invention comprises a fuel cell stack comprising a plurality of fuel cells, wherein each fuel cell comprises an anode side comprising a fuel inlet and a fuel outlet, a cathode side comprising an air inlet and an air outlet, and an electrolyte arranged between the anode side and the cathode side. The fuel cells may be of any suitable type known in the art. In particular, the fuel cells may be PEM fuel cells. The term “plurality” is to be understood as at least two. The number of fuel cells may vary depending on the required electric output of the fuel cell stack. The fuel cells in the fuel cell stack may be connected in series or may be connected in parallel to increase the total output current.

The fuel cell stack according to the present invention further comprises a cathode air intake arranged upstream from the air inlet. The cathode air intake may be in the form of a pipe having a cross-section of a suitable shape and size. Air flow per power unit at the cathode air intake may be from 10 to 60 Nl/min/kW, preferably 20 to 50 Nl/min/kW. The unit Nl/min stands for normal air liter per minute at +20° C. (+68° F.) and 1.01325 bar (14.69595 PSI).

In order to provide a sufficient amount of oxygen into the fuel cell stack, the intake air needs to be compressed. To this end, the fuel cell stack arrangement comprises a cathode air compressor arranged downstream from the cathode air intake. The compressor may be of any suitable type known in the art. Since increase in pressure leads to an increase in temperature, the compressed intake air may need to be cooled before it advances through the fuel cell stack arrangement. To this end, the fuel cell stack arrangement may comprise a cooling unit.

Hydrogen used in the fuel cells is supplied from a hydrogen gas storage tank arranged upstream from the fuel inlet. Hydrogen can be stored physically as either a gas or a liquid. Storage of hydrogen as a gas typically requires high-pressure tanks (350-700 bar tank pressure). Storage of hydrogen as a liquid requires cryogenic temperatures because the boiling point of hydrogen at one atmosphere pressure is −252.8° C.

The fuel cell stack arrangement further comprises a first separating unit comprising at least one disc stack separator, wherein the first separating unit is arranged between the cathode air intake and the air inlet. A disc stack separator comprises a plurality of rotating disc elements, wherein gas is present between the discs. Consequently, a disc stack separator comprises a plurality of narrow gaps between the discs, which allows for separation of small water droplets comprising particles and gases.

The present invention brings a lot of advantages over previously available solutions since a separating unit comprising at least one disc stack separator due to its capability to discharge both water droplets and particles improves the cleaning of the cathode air. It should further be emphasized that the arrangement of the present invention provides separation of water droplets as well as particles, thus allowing to replace a particle filter and a water separation unit, e.g. a liquid trap, by one single unit. Further, the arrangement of the present invention allows the cathode air to be purified, humidified and alkalinized, as will be described in greater detail below.

The first separating unit may comprise a plurality of disc stack separators in order to achieve an efficient purification of the intake air. Each disc stack separator of the first separating unit may comprise a rotor with a stack of narrowly spaced conical separation discs projecting into the compartment of the first separating unit. The disc stack separator may comprise from 20 to 250 discs, preferably from 100 to 200 discs. The separators may also be of a more basic type, having radial wings instead of conical discs in the rotor. Each separator may preferably be of a counter-current type, wherein the intake air flows radially inwards through the interspaces between the discs, against the pumping effect generated by rotational movement of the rotors. Alternatively, each separator may be of a co-current type. If a plurality of disc stack separator is used, each of the separators may be of same or different type.

In an embodiment wherein the separators are of a counter-current type, each separator rotor may further be provided with a fan which rotates together with the rotor. The fan may be located in an outlet chamber which is separate from and encloses the separating unit. The fan may be arranged for enhancing the flow of purified intake air from the separation unit to the air inlet of the fuel cell stack. Optionally, instead of an individual fan for each separator, a common fan may be arranged upstream or downstream of the separating unit for feeding the mixture of intake air, water and reaction products through the disc stack separators of the separating unit, and discharging the purified intake air to the air inlet of the fuel cell stack. The disc stack separators are driven either by an individual electric motor or by a common electric motor and a belt transmission.

The fuel cell stack arrangement according to the present invention may further comprise a treatment unit arranged between the cathode air intake and the first separating unit. Preferably, the treatment unit is arranged immediately upstream from the first separating unit. In the treatment unit, a first liquid, such as water, may be introduced into in the intake air flow for evaporative cooling, and saturation of the intake air. The first liquid is preferably in the form of an aerosol. By the term aerosol is in the context of the present invention understood a suspension of liquid droplets in the intake air. The treatment unit may be arranged for treating the intake air such that the intake air is humidified and harmful gases are removed. The treatment unit may be arranged for removal of harmful gases that may be present in the intake air. To this end, small droplets of a second liquid, such as an alkaline solution, may be introduced for adsorbing and dissolving the harmful gases. The second liquid may be in the form of an aerosol. Preferably, the size of the droplets in the treatment unit should be small enough not to be sedimented by gravitation and big enough to be centrifugally separated.

The air will thus enter the treatment unit, wherein harmful gases that may be present in the intake air are dissolved in the second water aerosol, while the intake air is humidified by the first aerosol. The water aerosol may be generated by high pressure nozzles or by piezoelectric crystals. The treatment unit and the first separating unit may be arranged upstream or downstream from the cathode air compressor. Preferably, the treatment unit and the first separating unit are arranged downstream from the cathode air compressor, such that water droplets generated when the compressed intake air is cooled may be removed by the first separating unit. If the treatment unit is present, the fuel cell stack arrangement according to the present invention offers the advantage of an even more compact and efficient treatment of the cathode air, wherein the particle filter, the cathode air cleaner and the humidifier are replaced by one unit.

The first separating unit may comprise a first water outlet through which the water separated in the first separating unit is discharged. The first water outlet may be in fluid communication with the treatment unit, such that the water discharged through the first water outlet is led to the treatment unit. Such an embodiment offers the advantage of a reduced water consumption.

The fuel cell stack arrangement according to the present invention may further comprise a second separating unit arranged between the fuel outlet and the fuel inlet. The second separating unit is configured to separate water droplets that may be present in the hydrogen gas before it is allowed to enter the fuel cells. The second separating unit may comprise a second water outlet for discharging the water separated by the second separating unit. Alternatively, the water separated by the second separating unit may be removed by evaporation, e.g. in the gas treatment unit.

Supplying the first and the second liquid in two separated steps has the following advantages. The initial step of introducing the first liquid, for example water, results in the evaporation that provides saturation and also cooling of a hot compressed intake air. The temperature of the compressed intake air immediately downstream from the cathode air compressor may be from 100° C. to 150° C. Once the intake air is saturated, evaporation stops. The evaporation and saturation in the first liquid introduction step importantly result in that the small droplets of the second liquid will keep their size. Saturation in the water introduction step effectively prevents evaporation from droplets introduced in the spraying step.

Preferably, the droplets of the second liquid should have a size small enough not to be sedimented by gravitation and big enough to be centrifugally separated. Thus, the droplets of the second liquid will be securely carried forward in the flow and separated from the flow in the centrifugal separation step.

The first liquid may be introduced by spraying small droplets of the first liquid into the flow. Small droplets provide quick saturation and resulting cooling.

The small droplets of the first liquid may be formed by atomization with pressurized air using a two-fluid nozzle or with high-pressure liquid spray using a single fluid nozzle. The two-fluid nozzle may be advantageous for creating very small droplets to obtain fastest possible cooling.

Small droplets of the second liquid may also be formed by atomization with pressurized air using a two fluid nozzle or with high-pressure liquid spray using a single fluid nozzle. The single fluid nozzle may be advantageous for producing more droplets per time unit, that in turn may also require a lower number of nozzles.

Atomization of the liquids will produce aerosols having small droplets for providing a large total surface area, enabling short reaction times for the first and second liquids with little or no need to slow down a given flow rate. By generating the atomization with pressurized air, the size of droplets can be controlled by varying flow rates of air and water or alkaline water solution.

The size of the droplets may also be controlled by varying only pressure of the pressurized air. That may be the case when atomizing nozzles and flow rate of alkaline solution are already determined.

The median size may be controlled to vary between about 1 and 200 μm, typically to be about 50 μm. Smaller droplets in the air flow may pass through the separation step in an undesired manner. The term “size” is to be understood as the size of a median sized droplet. For example, a median size of dv50 means that 50% of the droplet volume are drops having a diameter larger than dv50. The typical distribution of dv50 of 50 μm contains droplets from 20 to 130 μm (10% of the volume are droplets less than 20 μm and 90% of the volume are droplets less than 130 μm).

It should be noted that the droplet size of the first liquid should be kept as small as possible in order for the first liquid to evaporate completely. On the other hand, the droplet size of the second liquid should be kept large enough such that efficient separation of the contaminated droplets of the second liquid is possible.

Small droplets of the second liquid may be added to the air flow downstream from the first liquid, such that the air flow is already sufficiently saturated. Spraying of the aerosol droplets can be co-current or counter-current with the air flow.

While the purpose of the first liquid is only to saturate and cool the cathode intake air, the purpose of the second liquid is to absorb harmful gases. When the second liquid is added, the components of the second liquid react with the absorbed gas, thus reducing the gas concentration at the surface of the droplet so that more gas can be absorbed.

The first liquid may be water and the second liquid may be an alkaline water solution or any other solution aimed to react with the gases that are to be removed from the cathode intake air.

The treatment unit may comprise at least one spray nozzle for the first liquid, and at least one atomizing spray nozzle for the second liquid downstream of the at least one spray nozzle for the first liquid.

The fuel cell stack arrangement may also comprise a control and actuation unit capable of controlling the size of the droplets depending on the air flow on the cathode side. If the absorption is too low, the droplet size may be reduced. Further, the control unit may control rotational speed of the discs of the disc stack separator.

The present invention further relates to a method for treatment of cathode intake air of a fuel cell stack, the method comprising the steps of:
a) providing intake air;
b) compressing the intake air thus obtaining compressed intake air;
c) passing the intake air through a first separating unit comprising at least one disc stack separator, thus obtaining a purified intake air and a wastewater flow,
wherein steps b) and c) may occur in any order.

As mentioned above, the method of the present invention provides an improved treatment of the cathode intake air, wherein water droplets and particulate matter are removed using a single unit, i.e. the first separating unit. The intake air may be compressed before it is directed to the first separating unit. Alternatively, the intake air may be treated in the first separating unit before it is compressed. Regardless the order of steps b) and c), compressed purified intake air is released downstream from the first separating unit.

If a treatment unit is present in the fuel cell stack arrangement, the method of the present invention may further comprise a step of:
d) treating the intake air in a treatment unit comprising a second liquid thus obtaining treated intake air,
wherein step d) occurs before step c).

According to such an embodiment, the intake air is directed to the treatment unit, wherein aerosol comprising the second liquid, e.g. alkaline solution, dissolves harmful gaseous contaminants, such as NOx, NH₃, SO₂ and the like, at the same time providing humidity to the intake air. The intake air that have been treated in the treatment unit is subsequently directed to the first separating unit, wherein contaminated water droplets and the particulate matter are separated. Steps c) and d) may occur before or after step b). In other words, the intake air may be compressed before or after it passes through the treatment unit and the first separating unit.

The method according to the present invention may further comprise a step of:
e) directing the wastewater flow obtained in step c) to the treatment unit.

Thus, the wastewater flow separated by the first separation unit may be directed to the treatment unit, wherein it is re-used for providing the first aerosol for humidification and cooling. Such an embodiment offers the advantage of reducing the amount of water consumed during treatment of the intake air.

### BRIEF DESCRIPTION OF THE DRAWINGS

Embodiments of the invention will now be described by way of example with reference to the accompanying drawings, of which:

FIG. 1a depicts a fuel cell stack arrangement of the present invention;

FIG. 1b illustrates another embodiment of a fuel cell stack arrangement of the present invention;

FIG. 2 shows the fuel cell stack;

FIG. 3 illustrates a treatment unit and a first separating unit.

### DETAILED DESCRIPTION OF THE INVENTION

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical or similar reference numerals denote the same or similar components having a same or similar function, unless specifically stated otherwise.

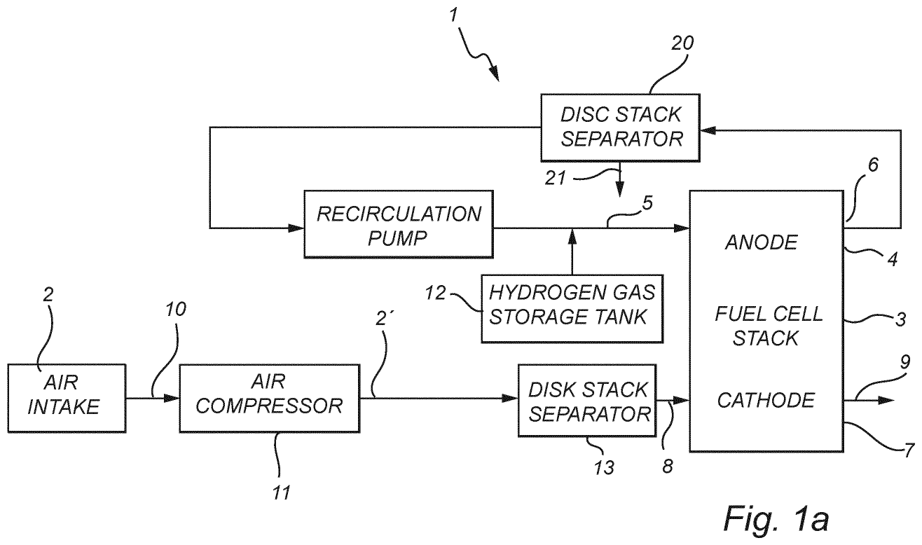

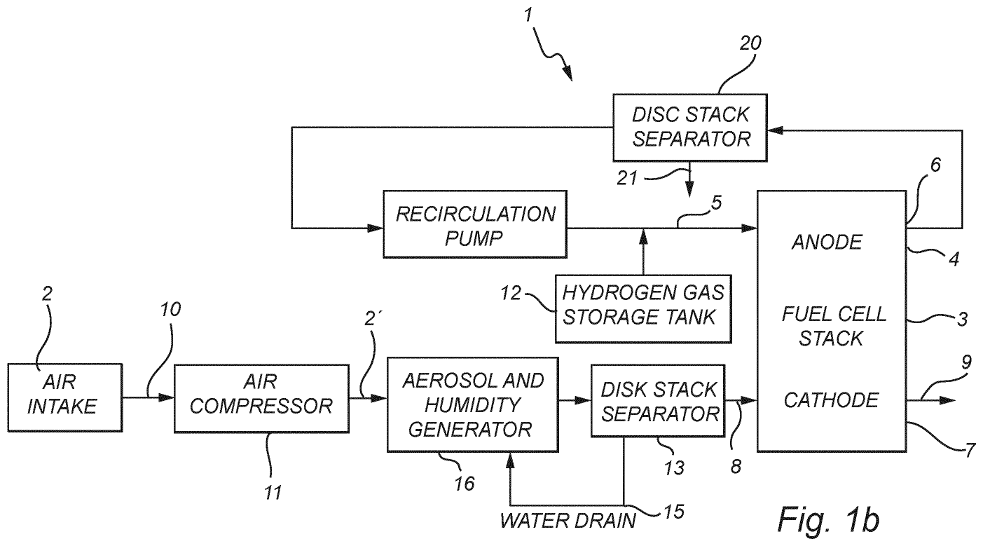

FIG. 1a illustrates a fuel cell stack arrangement 1 wherein water droplets and particles that disturb the fuel cells are removed from the cathode air 2, wherein the cathode air may be humidified and cooled. A fuel cell stack arrangement 1 depicted in FIG. 1a comprises a fuel cell stack 3 comprising a plurality of fuel cells (not shown), wherein each fuel cell comprises an anode side 4 comprising a fuel inlet 5 and a fuel outlet 6, a cathode side 7 comprising an air inlet 8 and an air outlet 9, and an electrolyte arranged between the anode side and the cathode side.

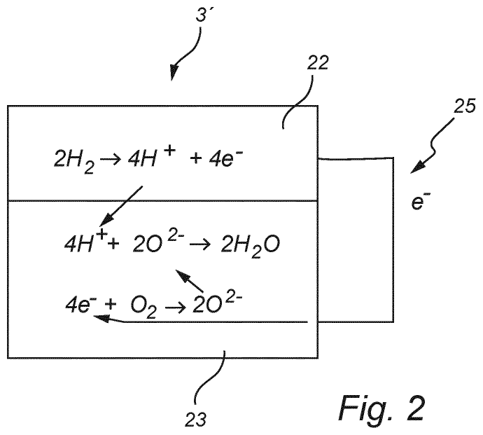

A fuel cell 3′ of the fuel cell stack 3 is shown in greater detail in FIG. 2. The fuel cell 3′ comprises an anode 22, a cathode 23, and an electrolyte 24 that allows protons to move between the two sides 22, 23 of the fuel cell 3′. At the anode 22, a catalyst causes the fuel, herein exemplified by hydrogen gas, to undergo oxidation reactions that generate hydrogen cations and electrons. The hydrogen cations move from the anode 22 to the cathode 23 through the electrolyte 24. At the same time, electrons flow from the anode 22 to the cathode 23 through an external circuit 25, producing direct current electricity. At the cathode 23, another catalyst causes hydrogen cations, electrons, and oxygen to react, forming water and possibly other products.

The fuel cell stack arrangement 1 further comprises a cathode air intake 10 arranged upstream from the air inlet 8. In order to provide a sufficient amount of oxygen into the fuel cell stack 3, the intake air needs to be compressed. To this end, the fuel cell stack arrangement 1 comprises a cathode air compressor 11 arranged downstream from the cathode air intake 10. The compressor 11 may be of any suitable type known in the art.

Hydrogen used in the fuel cells is supplied from a hydrogen gas storage tank 12 arranged upstream from the fuel inlet 5.

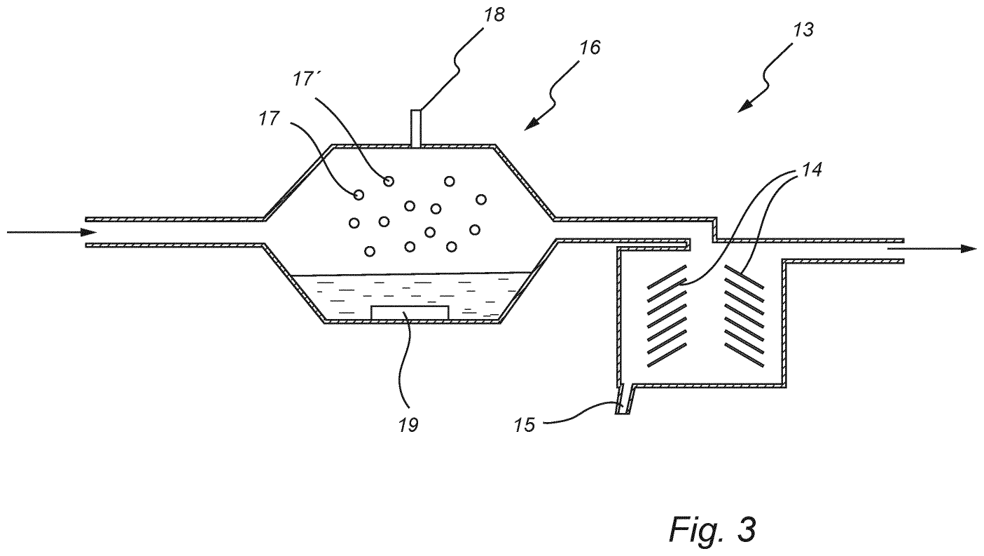

The fuel cell stack arrangement 1 further comprises a first separating unit 13 shown in greater detail in FIG. 3. The first separating unit 13 comprise at least one disc stack separator 14, wherein the first separating unit 13 is arranged between the cathode air intake 10 and the air inlet 8. The intake air 2 is directed to the first separating unit 13, where water droplets and particles are separated and discharged as a wastewater flow 15. The first separating unit is arranged downstream from the cathode air compressor 11.

The fuel cell stack arrangement 1 depicted in FIG. 1b is analogous to the one shown in FIG. 1a, however, it further comprises a treatment unit 16 arranged between the cathode air intake 10 and the first separating unit 13. As may be seen in FIG. 1b, the treatment unit 16 is arranged immediately upstream from the first separating unit 13. As mentioned above, the treatment unit 16 may be arranged for removal of harmful gases that may be present in the intake air 2. In the treatment unit 16, a first liquid 17, such as water, is introduced into in the intake air flow for evaporative cooling, saturation of the intake air 2. A second liquid may be added for adsorbing and dissolving the harmful gases. Preferably, the size of the droplets in the treatment unit should be small enough not to be sedimented by gravitation and big enough to be centrifugally separated.

The air 2 will thus enter the treatment unit 16, wherein the intake air 2 is humidified and cooled by the first water aerosol 17, while harmful gases that may be present in the intake air 2 are dissolved in the second water aerosol 17′. The water aerosols 17, 17′ may be generated by high pressure nozzles 18 or by piezoelectric crystals 19. The treatment unit 16 and the first separating unit 13 are arranged downstream from the cathode air compressor 11, such that water droplets generated when the compressed intake air 2′ is cooled may be removed by the first separating unit 13. The fuel cell stack arrangement 1 thus offers the advantage of a compact and efficient treatment of the cathode air 2, wherein the particle filter, the cathode air cleaner and the humidifier are replaced by one unit.

As may be seen in greater detail in FIG. 3, the first separating unit 13 comprises a first water outlet 15 through which the water separated in the first separating unit 13 is discharged. The first water outlet 15 is in fluid communication with the treatment unit 16, such that the water discharged through the first water outlet 15 is led to the treatment unit 16. Such an embodiment offers the advantage of a reduced water consumption.

The fuel cell stack arrangement 1 further comprises a second separating unit 20 arranged between the fuel outlet 6 and the fuel inlet 5. The second separating unit 20 is configured to separate water droplets that may be present in the hydrogen gas before it is allowed to enter the fuel cells. The second separating unit 20 comprises a second water outlet 21 for discharging the water separated by the second separating unit 20.

Although the present invention has been described with reference to various embodiments, those skilled in the art will recognize that changes may be made without departing from the scope of the invention. It is intended that the detailed description be regarded as illustrative and that the appended claims including all the equivalents are intended to define the scope of the invention.

1. A fuel cell stack arrangement comprising:
a fuel cell stack comprising a plurality of fuel cells, wherein each fuel cell comprises an anode side comprising a fuel inlet and a fuel outlet, a cathode side comprising an air inlet and an air outlet, and an electrolyte arranged between said anode side and said cathode side;
a cathode air intake arranged upstream from said air inlet;
a cathode air compressor arranged downstream from said cathode air intake;
a hydrogen gas storage tank arranged upstream from said fuel inlet;
wherein said fuel cell stack arrangement further comprises a first separating unit comprising at least one disc stack separator and being arranged between said cathode air intake and said air inlet.

2. The fuel cell stack arrangement according to claim 1, wherein said fuel cell stack arrangement further comprises a second separating unit comprising at least one disc stack separator and being arranged between said fuel outlet and said fuel inlet.

3. The fuel cell stack arrangement according to claim 2, wherein said second separating unit further comprises a second water outlet.

4. The fuel cell stack arrangement according to claim 1, wherein said fuel cell stack arrangement further comprises a treatment unit comprising a first liquid and being arranged between said cathode air intake and said first separating unit.

5. The fuel cell stack arrangement according to claim 4, wherein said first liquid is water.

6. The fuel cell stack arrangement according to claim 4, wherein said first separating unit comprises a first water outlet, wherein said first water outlet is in fluid communication with said treatment unit.

7. The fuel cell stack arrangement according to claim 4, wherein said treatment unit comprises droplets of said first liquid, said droplets having particle size in a range from 1 μm to 200 μm.

8. The fuel cell stack arrangement according to claim 4, wherein said treatment unit comprises a second liquid.

9. The fuel cell stack arrangement according to claim 1, wherein air feed rate at said cathode air intake is from 10 to 60 Nl/min/kW.

10. The fuel cell stack arrangement according to claim 1, wherein said at least one disc stack separator comprises a stack of spaced conical separation discs.

11. The fuel cell stack arrangement according to claim 10, wherein said disc stack separator comprises from 20 to 250 discs.

12. A method for treatment of cathode intake air of a fuel cell stack, comprising:
a) providing intake air;
b) compressing said intake air thus obtaining compressed intake air;
c) passing said intake air through a first separating unit comprising at least one disc stack separator, thus obtaining a purified intake air and a wastewater flow.

13. The method according to claim 12, further comprising:
d) treating said intake air in a treatment unit comprising a first liquid thus obtaining treated intake air,
wherein step d) occurs before step c).

14. The method according to claim 13, further comprising:
e) directing said wastewater flow obtained in step c) to said treatment unit.
